(19) United States
(12) Patent Application Publication
(10) Pub. No.: US 2014/0238791 A1
(43) Pub. Date: Aug. 28, 2014

(54) COOLING DEVICE FOR A BRAKING SYSTEM

(71) Applicant: Wayne-Ian Moore, Changhua County (TW)

(72) Inventor: Wayne-Ian Moore, Changhua County (TW)

(21) Appl. No.: 13/775,126

(22) Filed: Feb. 23, 2013

(51) Int. Cl. F16D 65/847

(52) U.S. Cl. CPC F16D 65/847
USPC 188/264 A

(57) ABSTRACT

A cooling device for a braking system, includes a blower having a case and a fan, the case having an air outlet opened at one end thereof and an air inlet opened at another end thereof, the case having a receiving room, the receiving room communicating with the air outlet and the air inlet, the fan rotatably assembled in the receiving room, the blower further having a power supplier electrically connected to the fan, the power supplier being used to power the fan, one end of a frame connected to a hydraulic braking system, another end of the frame connected to the case. Under this arrangement, the blower directly blows the hydraulic braking system so as to efficiently cool the hydraulic braking system.

### BACKGROUND OF THE INVENTION

1. Field of the Invention

The present invention relates to a cooling device, and more particularly to a cooling device for a braking system.

2. Description of Related Art

Bicycles are very popular today. When a rider rides a bicycle along a downhill, a braking system ensures the safety for the rider. Recently, the braking system is driven by a hydraulic system which drives two clamping plates in the braking system to clamp a braking disc, so as to slow down a rotational speed of wheels of the bicycle. In addition, when the rider rides along the downhill, the rider needs to frequently brake the bicycle because of safety; as a result, the clamping plates would be overheated and a friction efficiency between each clamping plate and the braking disc would be further reduced. Therefore, how to cool the clamping plates is an important topic in this related art.

Some manufacturers set a plurality of openings opened around the braking disc so as to allow ambient air to flow through the openings, so that the ambient air flowing through the openings could absorb the heat emitted from the clamping plates; as a result, the clamping plates are cooled when the braking disc rotates. However, although the ambient air flowing through the openings absorbs the heat emitted from the clamping plates, said ambient air just indirectly blows the clamping plates rather than directly blow the clamping plates. Therefore, the clamping plates cannot be cooled efficiently.

The present invention has arisen to mitigate and/or obviate the disadvantages of the conventional braking system.

### SUMMARY OF THE INVENTION

The main objective of the present invention is to provide an improved cooling device.

To achieve the objective, a cooling device for a braking system, which is assembled onto a hydraulic braking system of a bicycle, comprises a blower having a case and a fan, the case having an air outlet opened at one end thereof and an air inlet opened at another end thereof, the air outlet corresponding to the hydraulic braking system, the case having a receiving room defined therein, the receiving room communicating with the air outlet and the air inlet, the fan rotatably assembled in the receiving room, the blower further having a power supplier electrically connected to the fan, the power supplier being used to power the fan, one end of a frame connected to the hydraulic braking system, another end of the frame connected to the case of the blower. Wherein, the blower is further controlled by a wired controller or a wireless controller which is assembled onto a handlebar of a bicycle; the wired controller has a starter and a switch plate; one end of the starter faces the handlebar; another end of the starter faces a brake lever; one end of the switch plate is pivoted on another end of the starter; a spring is assembled between the starter and the switch plate; one end of the spring abuts against the starter; another end of the spring abuts against the switch plate; when a rider pulls the brake lever to operate the hydraulic braking system, the switch plate is smoothly pressed by the brake lever; as a result, the starter starts the power supplier to power the blower; the wired controller further has an electric wire; the electric wire is electrically connected between the starter and the power supplier of the blower; the wireless controller has a detector; the detector corresponds to one side of a brake lever; the detector is used to detect a motion of the brake lever; the detector is wirelessly connected to the power supplier of the blower; the frame has a positioning portion; the positioning portion is connected to the hydraulic braking system; the frame has a connecting portion; the connecting portion is connected to the blower; the frame has a middle portion; the middle portion is defined between the positioning portion and the connecting portion; the connecting portion has an assembling hole opened therethrough; the case of the blower has an assembling opening opened therethrough; the assembling opening of the case corresponds to the assembling hole of the connecting portion; a screw unit passes through the assembling hole and is further screwed into the assembling opening, so that the blower is assembled on the frame; the positioning portion of the frame has a positioning hole opened therethrough; a screw member passes through the positioning hole and a further positioning hole of the hydraulic braking system, and is further screwed into a tube near a brake disk of a bicycle, so that the frame is positioned on the tube near the brake disk of the bicycle; the positioning portion is perpendicularly connected to one end of the middle portion; another end of the middle portion is perpendicularly connected to the connecting portion, so that the frame is generally U-shaped; the connecting portion is inclinedly extended relative to the blower.

Therefore, the blower directly blows the hydraulic braking system so as to efficiently cool the hydraulic braking system.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a cooling device for a braking system of the present invention;

FIG. 2 is a side view for showing a blower which corresponds to a hydraulic braking system;

FIG. 3 is a perspective view for showing a wired controller of the present invention; and

FIG. 4 is a perspective view for showing a wireless controller of the present invention.

### DETAILED DESCRIPTION OF THE INVENTION

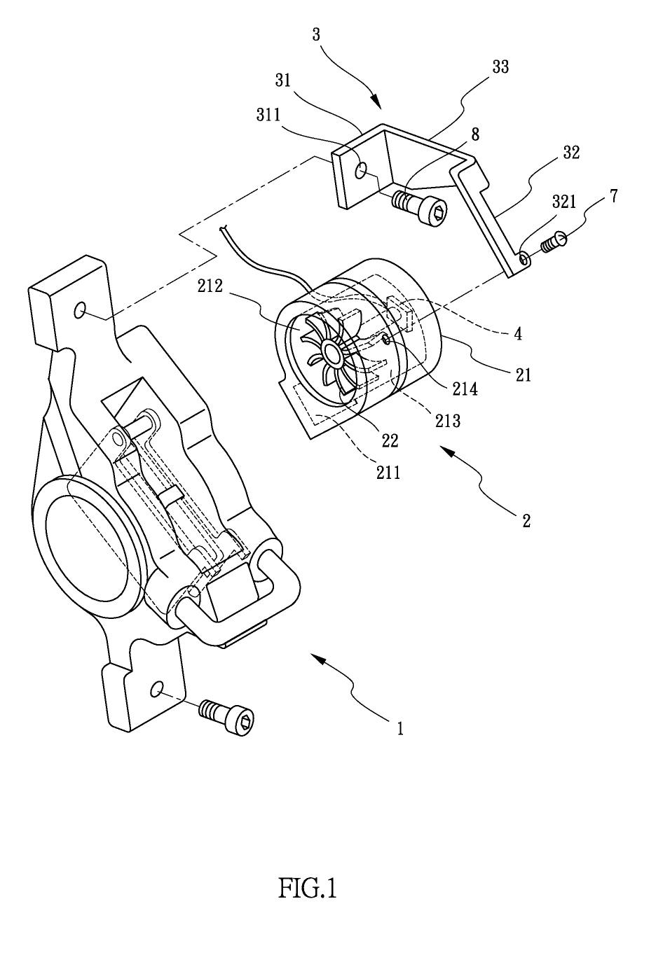

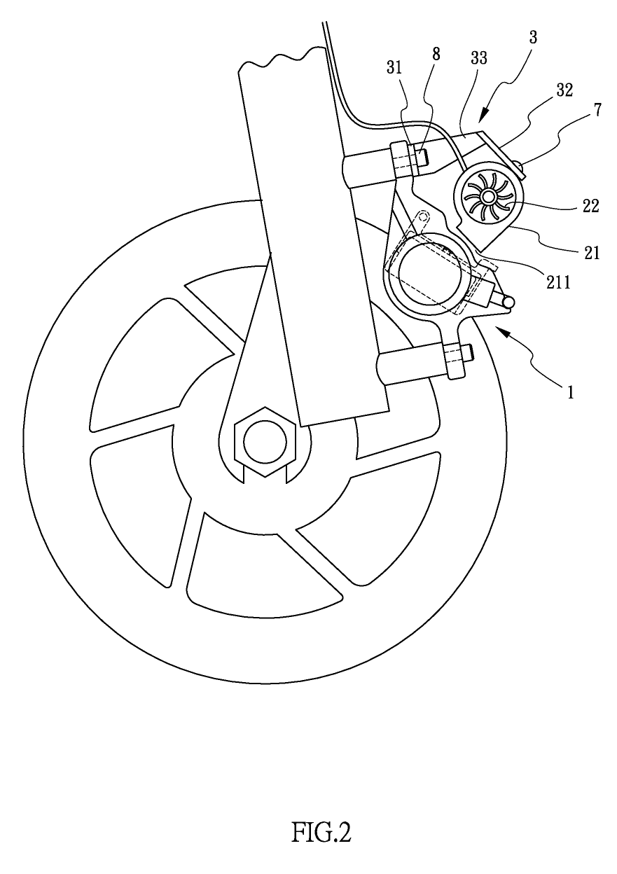

Referring to FIGS. 1-4, a cooling device for a braking system in accordance with the present invention is assembled onto a hydraulic braking system 1 of a bicycle (not shown). The cooling device for a braking system comprises a blower 2 and a frame 3. The blower 2 has a case 21 and a fan 22. The case 21 has an air outlet 211 opened at one end thereof. The air outlet 211 corresponds to the hydraulic braking system 1. The case 21 has an air inlet 212 opened at another end thereof. The case 21 has a receiving room 213 defined therein. The receiving room 213 communicates with the air outlet 211 and the air inlet 212. The fan 22 is rotatably assembled in the receiving room 213. The blower 2 further has a power supplier 4 electrically connected to the fan 22. The power supplier 4 is used to power the fan 22. One end of the frame 3 is connected to the hydraulic braking system 1. Another end of the frame 3 is connected to the case 21 of the blower 2. Under this arrangement, when the power supplier 4 powers the fan 22 of the blower 2, the fan 22 rotates via said power from the power supplier 4; then, ambient air around the blower 2 flows toward the air inlet 212 of the blower 2 via said rotation of the fan 22; thereafter, the ambient air flowing toward the air inlet 212 further flows into the receiving room 213 of the blower 2 via the air inlet 212; finally, the ambient air in the receiving room 213 further flows toward the hydraulic braking system 1 via the air outlet 211 of the blower 2. Therefore, the blower 2 directly blows the hydraulic braking system 1 so as to efficiently cool the hydraulic braking system 1 (the above disclosure is enough to be used to perform a basic embodiment of the present invention).

The blower 2 is further controlled by a wired controller 5 or a wireless controller 6.

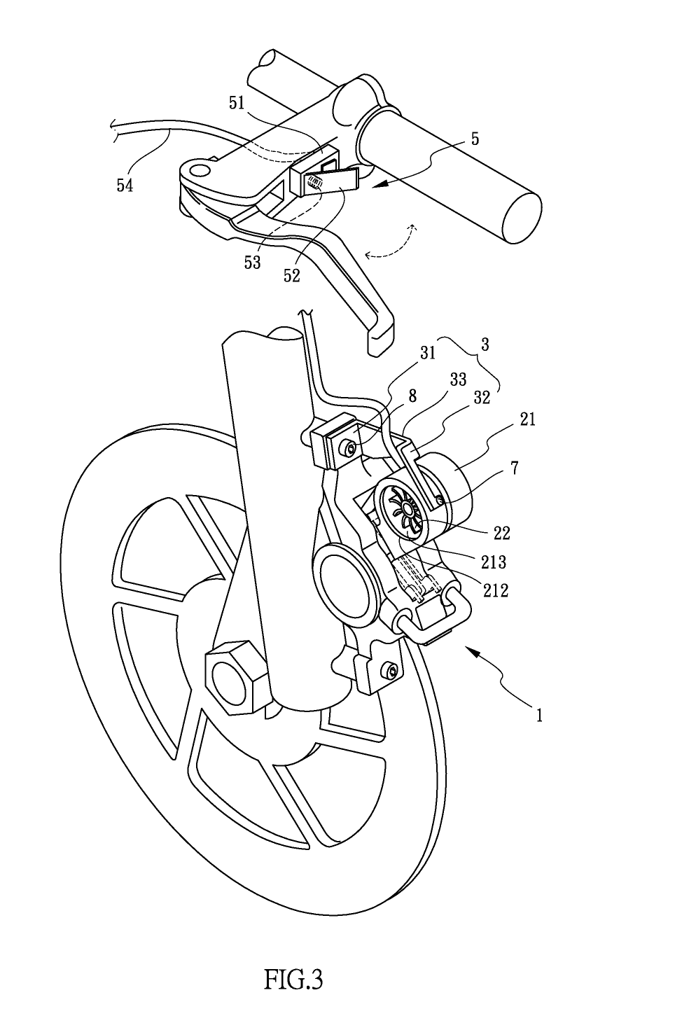

In regards to the wired controller 5, the wired controller 5 is assembled onto a handlebar (as shown in FIG. 3) of a bicycle (not shown). The wired controller 5 has a starter 51 and a switch plate 52. One end of the starter 51 faces the handlebar. Another end of the starter 51 faces a brake lever (as shown in FIG. 3). One end of the switch plate 52 is pivoted on another end of the starter 51. The wired controller 5 further has an electric wire 54. The electric wire 54 is electrically connected between the starter 51 and the power supplier 4 of the blower 2, so that the starter 51 can start the power supplier 4 to power the blower 2 via the electric wire 54. Under this arrangement, when a rider pulls the brake lever to operate the hydraulic braking system 1, the switch plate 52 is smoothly pressed by the brake lever; as a result, the starter 51 starts the power supplier 4 to power the blower 2 by said press.

In addition, a spring 53 is assembled between the starter 51 and the switch plate 52. When the rider pulls the brake lever to operate the hydraulic braking system 1, the spring 53 is compressed by the switch plate 52; one end of the spring 53 abuts against the starter 51; another end of the spring 53 abuts against the switch plate 52. In contrast, when the rider releases the brake lever, the switch plate 52 is moved to an initial position thereof by a recovery force of the spring 53; as a result, the starter 51 stops starting the blower 2 via said motion of the switch plate 52. Therefore, the blower 2 stops operating when the hydraulic braking system 1 is not operated.

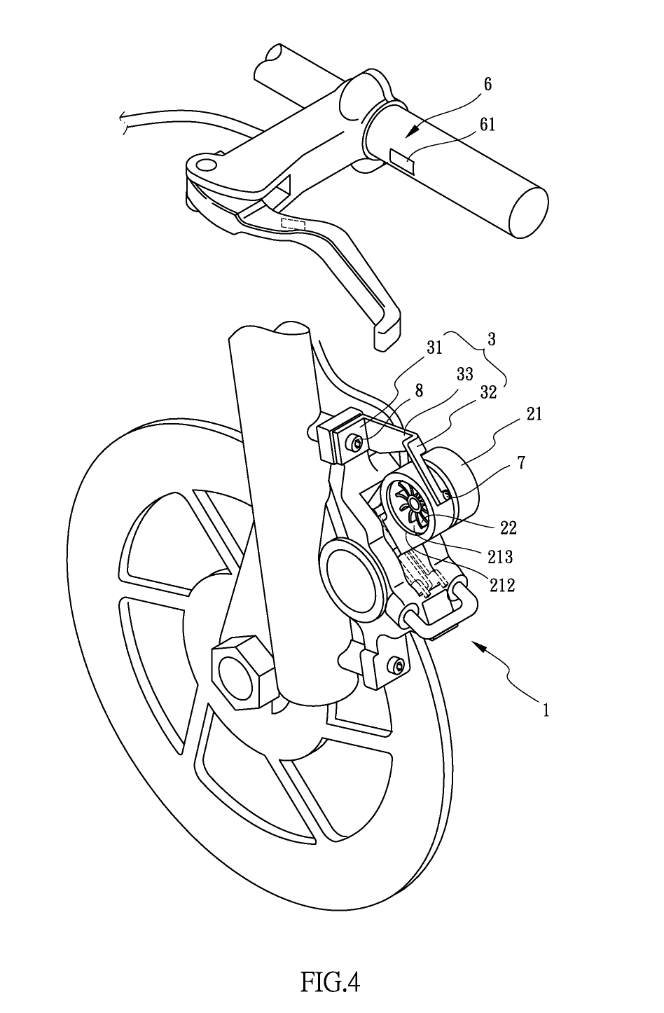

In regards to the wireless controller 6, the wireless controller 6 is assembled onto a handlebar (as shown in FIG. 4) of a bicycle (not shown). The wireless controller 6 has a detector 61. The detector 61 corresponds to one side of a brake lever (as shown in FIG. 4). The detector 61 is wirelessly connected to the power supplier 4 of the blower 2. Said wireless connection might be performed as an infrared connection, a WIFI connection or a Bluetooth connection. Under this arrangement, when the rider pulls the brake lever to operate the hydraulic braking system 1, the detector 61 at the handlebar detects a motion of the brake lever; then, the detector 61 sends a starting signal to the power supplier 4 via said wireless connection; as a result, the power supplier 4 starts powering the blower 2 because of said starting signal.

Furthermore, the frame 3 has a positioning portion 31. The positioning portion 31 is connected to the hydraulic braking system 1 so as to position the frame 3 onto the hydraulic braking system 1. The frame 3 has a connecting portion 32. The connecting portion 32 is connected to the blower 2 so as to connect the blower 2 to the frame 3. The frame 3 has a middle portion 33. The middle portion 33 is defined between the positioning portion 31 and the connecting portion 32. The positioning portion 31, the connecting portion 32 and the middle portion 33 are all plate-shaped. The connecting portion 32 has an assembling hole 321 opened therethrough. The case 21 of the blower 2 has an assembling opening 214 opened therethrough. The assembling opening 214 of the case 21 corresponds to the assembling hole 321 of the connecting portion 32. A screw unit 7 passes through the assembling hole 321 and is further screwed into the assembling opening 214, so that the blower 2 is assembled on the frame 3. The positioning portion 31 of the frame 3 has a positioning hole 311 opened therethrough. A screw member 8 passes through the positioning hole 311 and a further positioning hole of the hydraulic braking system 1 (as shown in FIG. 1), and is further screwed into a tube near a brake disk of a bicycle (not shown), so that the frame 3 is positioned on the tube near the brake disk of the bicycle. The positioning portion 31 is perpendicularly connected to one end of the middle portion 33. Another end of the middle portion 33 is perpendicularly connected to the connecting portion 32, so that the frame 3 is generally U-shaped. Besides, the connecting portion 32 is inclinedly extended relative to the blower 2, so as to fit the blower 2 (as shown in FIG. 1). Therefore, the blower 2 is prevented from dropping down or knocking against the hydraulic braking system 1 during riding.

Although the invention has been explained in relation to its preferred embodiment, it is to be understood that many other possible modifications and variations can be made without departing from the spirit and scope of the invention as hereinafter claimed.

What is claimed is:

1. A cooling device for a braking system, which is assembled onto a hydraulic braking system of a bicycle, comprising:
a blower having a case and a fan, the case having an air outlet opened at one end thereof and an air inlet opened at another end thereof, the air outlet corresponding to the hydraulic braking system, the case having a receiving room defined therein, the receiving room communicating with the air outlet and the air inlet, the fan rotatably assembled in the receiving room, the blower further having a power supplier electrically connected to the fan, the power supplier being used to power the fan; and
one end of a frame connected to the hydraulic braking system, another end of the frame connected to the case of the blower;
wherein, the blower directly blows the hydraulic braking system so as to efficiently cool the hydraulic braking system.

2. The cooling device for a braking system as claimed in claim 1, wherein the blower is further controlled by a wired controller or a wireless controller which is assembled onto a handlebar of a bicycle.

3. The cooling device for a braking system as claimed in claim 2, wherein the wired controller has a starter and a switch plate; one end of the starter faces the handlebar; another end of the starter faces a brake lever; one end of the switch plate is pivoted on another end of the starter; a spring is assembled between the starter and the switch plate; one end of the spring abuts against the starter; another end of the spring abuts against the switch plate; when a rider pulls the brake lever to operate the hydraulic braking system, the switch plate is smoothly pressed by the brake lever; as a result, the starter starts the power supplier to power the blower.

4. The cooling device for a braking system as claimed in claim 3, wherein the wired controller further has an electric wire; the electric wire is electrically connected between the starter and the power supplier of the blower.

5. The cooling device for a braking system as claimed in claim 2, wherein the wireless controller has a detector; the detector corresponds to one side of a brake lever; the detector is used to detect a motion of the brake lever; the detector is wirelessly connected to the power supplier of the blower.

6. The cooling device for a braking system as claimed in claim 1, wherein the frame has a positioning portion; the positioning portion is connected to the hydraulic braking system; the frame has a connecting portion; the connecting portion is connected to the blower; the frame has a middle portion; the middle portion is defined between the positioning portion and the connecting portion; the connecting portion has an assembling hole opened therethrough; the case of the blower has an assembling opening opened therethrough; the assembling opening of the case corresponds to the assembling hole of the connecting portion; a screw unit passes through the assembling hole and is further screwed into the assembling opening, so that the blower is assembled on the frame.

7. The cooling device for a braking system as claimed in claim 6, wherein the positioning portion of the frame has a positioning hole opened therethrough; a screw member passes through the positioning hole and a further positioning hole of the hydraulic braking system, and is further screwed into a tube near a brake disk of a bicycle, so that the frame is positioned on the tube near the brake disk of the bicycle; the positioning portion is perpendicularly connected to one end of the middle portion; another end of the middle portion is perpendicularly connected to the connecting portion, so that the frame is generally U-shaped; the connecting portion is inclinedly extended relative to the blower.
